(19) United States
(12) Patent Application Publication
(10) Pub. No.: US 2021/0047772 A1
(43) Pub. Date: Feb. 18, 2021

(54) LAUNDRY TREATMENT DEVICE

(71) Applicant: LG ELECTRONICS INC., Seoul (KR)

(72) Inventors: Juhyuck JANG, Seoul (KR); Junyoung CHOI, Seoul (KR)

(21) Appl. No.: 16/992,635

(22) Filed: Aug. 13, 2020

(30) Foreign Application Priority Data
Aug. 13, 2019 (KR) 10-2019-0099026

(51) Int. Cl. D06F 58/10; D06F 58/22; B01D 46/00; B01D 46/42; D06F 58/20; B01D 46/10

(52) U.S. Cl. CPC D06F 58/10; D06F 58/22; B01D 46/0013; B01D 46/4227; B01D 2279/55; B01D 46/0006; B01D 46/10; B01D 2273/30; D06F 58/203

(57) ABSTRACT

A clothing treatment device includes: a cabinet forming a treatment space in which clothing is accommodated; a door configured to open and close the opened front of the cabinet; a machine compartment having a suction port and a discharge port, the suction port through which air of the treatment space is suctioned, the discharge port through which air is discharged to the treatment space; and a filter module disposed below the treatment space. The filter module includes: a module cover disposed at a lower side of the treatment space; and a filter unit disposed inside the module cover so that the filter unit is allowed to be withdrawn toward a front of the module cover when the door opens the opened front of the cabinet, the filter unit which filters out foreign substances falling down on the module cover.

### CROSS-REFERENCE TO RELATED APPLICATION

This application claims priority under 35 U.S.C. § 119 to Korean Application No. 10-2019-0099026 filed on Aug. 13, 2020, whose entire disclosure is hereby incorporated by reference.

### BACKGROUND

### 1. Field

The present disclosure relates to a clothing treatment device, and more particularly, to a clothing treatment device in which a filter portion is disposed below the treatment space.

### 2. Background

Clothing treatment devices are apparatuses that treat clothing, e.g. wash and dry clothing and smooth wrinkles in clothing, at home or at laundromats.

Clothing treatment devices may be classified into a washer for washing clothing, a dryer for drying clothing, a washer/dryer having both a washing function and a drying function, a refresher for refreshing clothing, and a steamer for removing unnecessary wrinkles in clothing.

The refresher is an apparatus that keep clothing comfortable and fresh. The refresher functions to dry clothing, to supply fragrance to clothing, to prevent the occurrence of static electricity in clothing, or to remove wrinkles from clothing. Therefore, it is possible to refresh clothing located inside the treatment space by the flow of air in the treatment space for processing the clothing.

Korean Patent Application Publication No. 1020180133830 discloses a clothing treatment device for refreshing clothing located inside the treatment space by the flow of air within a treatment space for processing clothing. However, the clothing treatment device disclosed above has a structure in which a bottom surface is formed at a lower side of the treatment space and a grille for a suction port and a discharge port is formed at a portion of the bottom surface, and thus, there is a problem that foreign substances falling down from clothing by air flowing in the treatment space is accumulated in the bottom surface except for the suction port and the discharge port.

That is, the foreign substances accumulated at the lower side of the treatment space may flow to clothing by the flow of air, thereby causing a problem that the clothing cannot be refreshed.

The above references are incorporated by reference herein where appropriate for appropriate teachings of additional or alternative details, features and/or technical background.

### BRIEF DESCRIPTION OF THE DRAWINGS

The embodiments will be described in detail with reference to the following drawings in which like reference numerals refer to like elements wherein:

FIG. 1 is a view of a clothing treatment device with a door opened, according to an embodiment of the present disclosure.

FIG. 2 is a view of FIG. 1 with a filter module removed.

FIG. 3 is a perspective view of a filter module according to an embodiment of the present disclosure.

FIG. 4 is an exploded perspective view of a filter module according to an embodiment of the present disclosure.

FIG. 5A is a view illustrating a state in which a filter unit is withdrawn from or inserted into a filter cover according to an embodiment of the present disclosure.

FIG. 5B is a view illustrating a state in which a filter cover is opened according to an embodiment of the present disclosure.

FIG. 6 is a perspective view of a module cover and a filter unit mounted on a discharge port cover according to an embodiment of the present disclosure.

FIG. 7 is a view illustrating a cross-sectional view of a filter module and a portion of a discharge port forming surface according to an embodiment of the present disclosure cut in the front-rear direction.

FIG. 8 is an enlarged view of a portion A of FIG. 7.

FIG. 9 is a view for describing a hinge portion and a hinge corresponding portion of the upper grille and the lower plate according to an embodiment of the present disclosure.

FIG. 10 is a view for describing a relationship between a filter module, a front of a machine compartment, and a slope of a door according to an embodiment of the present disclosure.

### DETAILED DESCRIPTION

Advantages and features of the inventive concept and methods of accomplishing the same may be understood more readily by reference to the following detailed description of exemplary embodiments and the accompanying drawings. The inventive concept may, however, be embodied in many different forms and should not be construed as being limited to the embodiments set forth herein. Rather, these embodiments are provided so that this disclosure will be thorough and complete and will fully convey the concept of the invention to those skilled in the art, and the inventive concept will only be defined by the appended claims. Like reference numerals refer to like elements throughout the specification.

Hereinafter, the present disclosure will be described with reference to the drawings for explaining a clothing treatment device according to embodiments of the present disclosure.

### <Overall Configurations>

Referring to 1, 2 and 10, overall configurations of a clothing treatment device according to the present embodiment will be schematically described.

A clothing treatment apparatus 1 of the present disclosure may supply steam or hot air to a treatment object (hereinafter referred to as “clothing”), such as clothing placed in the inside, or may supply dry air at a high temperature. In addition, the clothing treatment device 1 may shake off foreign substances from the clothing by applying vibration to the clothing placed in the inside.

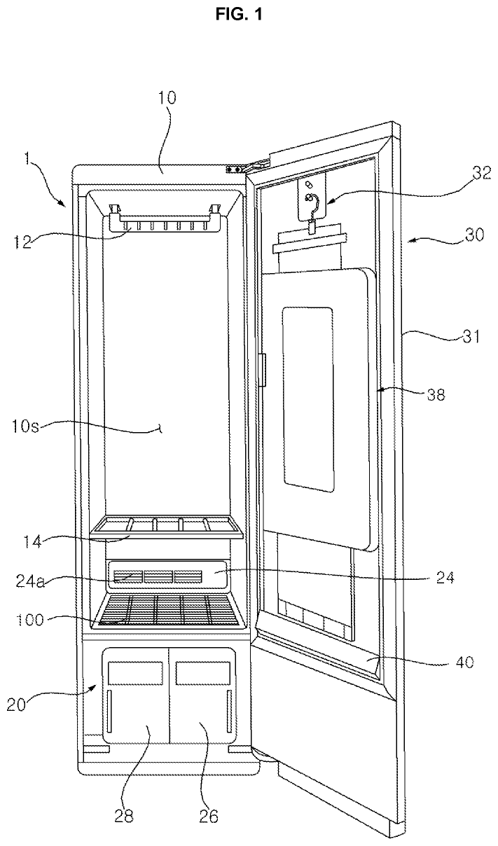

Referring to FIG. 1, the clothing treatment device 1 according to the present disclosure forms a treatment space 10s in which a subject to be processed such as clothing is placed, a cabinet 10 having a front opened, a door 30 which opens and closes the opened front of the cabinet 10, and a machine compartment 20 which is disposed at a lower side of the treatment space 10s and which circulates air with the treatment space.

Within the cabinet 10, a clothing hanger 12 may be disposed in an upper side of the treatment space 10s to hang clothing received in the treatment space 10s, and a shelf 14 in which a small-sized treatment object placed in the treatment space 10s is held may be disposed.

The clothing hanger 12 may be vibrated by a vibration module (not shown) disposed inside the cabinet 10. According to the vibration of the vibration module, the clothing hanger 12 may shake clothing hanging on the clothing hanger 12 to shake off foreign substances from the clothing. The shelf 14 is detachably disposed in the treatment space 10s of the cabinet 10.

The door 30 includes a door plate 31 which covers the front of the cabinet 10, a presser 38 which is located at an inner surface of the door plate 31 facing the treatment space 10s when the door plate 31 is closed and which is configured to apply pressure to clothing, and a clothing fixing portion 32 which fixes the position of clothing located at the presser 38. The clothing fixing portion 32 fixes clothing at the upper side of a presser 38 such that the clothing is stretched downward.

The door 30 includes a slope (or sloped region) 40 disposed below the presser 38 and guiding a condensate flowing down the door 30 to a suction port 22a. The slope 40 protrudes obliquely from the inner surface of the door 30 toward the treatment space 10s. The slope 40 is formed in an upper side of the machine compartment 20, and a width thereof protruding from the door 30 increases in a downward direction.

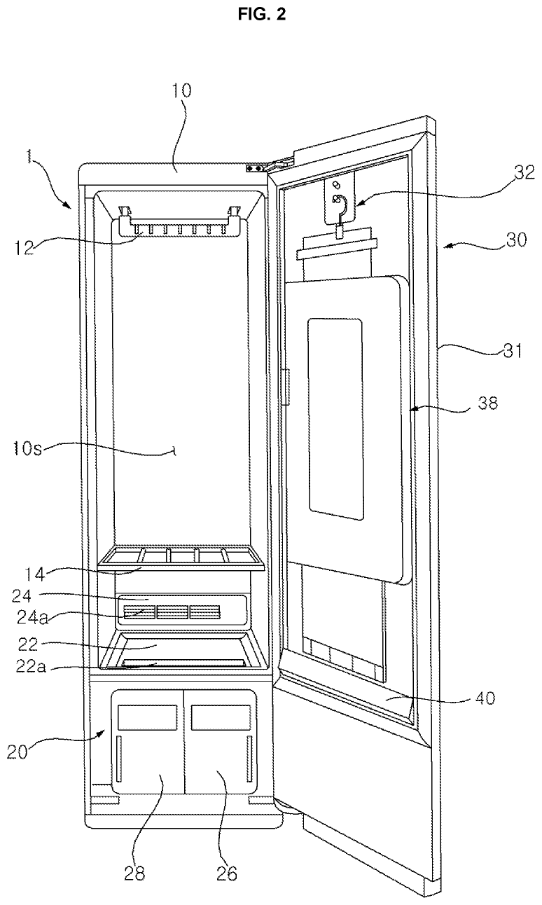

Referring to FIG. 2, the machine compartment 20 is disposed inside the cabinet 10 and below the treatment space 10s to circulate air of the treatment space. In the machine compartment 20, the suction port 22a through which air is suctioned into the machine compartment 20 and a discharge port 24a through which air inside the machine compartment 20 is discharged to the processing room 10s are formed in the upper surface facing the treatment space 10s.

Referring to FIG. 1, a filter module 100 collecting foreign substances falling to a lower side of the treatment space 10s or filtering out foreign substances in air introduced through the suction port 22a is disposed at an upper side of the machine compartment 200. At the upper surface of the machine compartment 20, a mounting surface 22 forming a space in which the filter module 100 is mounted and a discharge port cover 24 in which a discharge port 24a is formed are disposed. At one side of the mounting surface 22, the suction port 22a through which air inside the treatment space 10s is introduced into the machine compartment 20 is formed.

The discharge port cover 24 may also be disposed to be detachable upwards of the machine compartment 20. The filter module 100 is disposed to be detachable upwards of the machine compartment 20 in a state in which the discharge port cover 24 is mounted above the machine compartment 20.

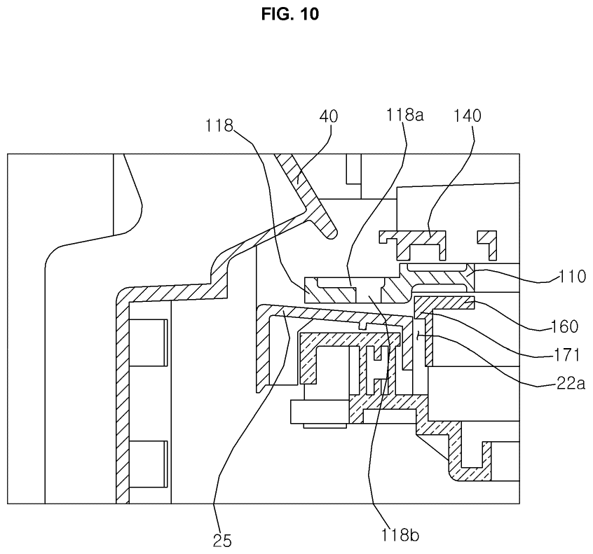

Referring to FIG. 10, a front holding portion (or front liner) 25 in which a front end of a lower plate (or tray) 160 described below is held is dispose at a front of the suction port 22a of the mounting surface 22. The machine compartment 20 includes a front holding portion 25 which is disposed at the front of the suction port 22a on an upper surface and in which the lower plate 160 of the filter module 100 to be described below is held.

The front holding portion 25 is disposed below the slope 40. The front holding portion 25 has a shape that is inclined downward toward a rear, and the suction port 22a is formed at a rear end. A handle 118 of a filter unit 110 to be described below is disposed above the front holding portion 25

The filter module 100 may be disposed above the machine compartment 20 to be substantially parallel to the ground, and the discharge port cover 24 may be disposed above the filter module 100 to be in an inclined shape.

A fan (not shown) for causing air introduced into the suction port 22a to flow into the discharge port 24a, an air treatment part (not shown) for performing treatment on air introduced into the machine compartment 20, and a steam supply unit (not shown) for generating steam by heating water and then transmitting the generated stem to the treatment space 10s may be disposed inside the machine compartment 20.

The air treatment part circulates a refrigerant through compression, condensation, expansion, and evaporation processes, such that air introduced through the suction port 22a can be condensed through heat exchange with the refrigerant and heated, thereby transmitting hot and dry air to the discharge port 24a.

The machine compartment 20 includes a first tank 26 for supplying water to the steam supply unit, and a second tank 28 for storing a condensate created by condensation of air inside the machine compartment 20.

### <Filter Module>

Referring to FIGS. 1 to 10, a filter module of the present disclosure and a configuration associated with the filter module will be described.

Referring to FIG. 1, the filter module 100 collects foreign substances contained in air falling from the treatment space 10s or filters out foreign substances flowing to the suction port. The filter module 100 is disposed at an upper surface of the machine compartment 20. The filter module 100 is disposed at an upper side of the mounting surface 22 of the machine compartment.

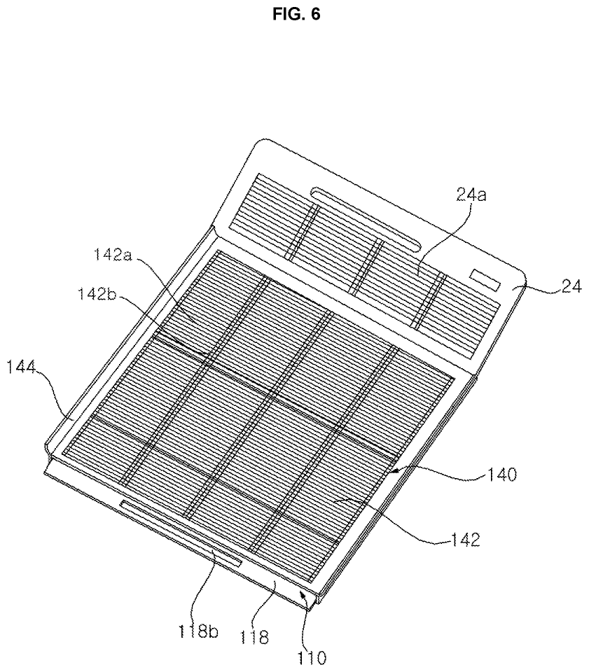

Referring to FIG. 7, a module cover (or housing) 130 includes an accommodation space 132 in which the filter unit 110 is disposed, an opening 134 through which the filter unit 110 is to be inserted or withdrawn is formed at a front of the accommodation space 132, and the filter unit 110 is slidably coupled to the module cover 130.

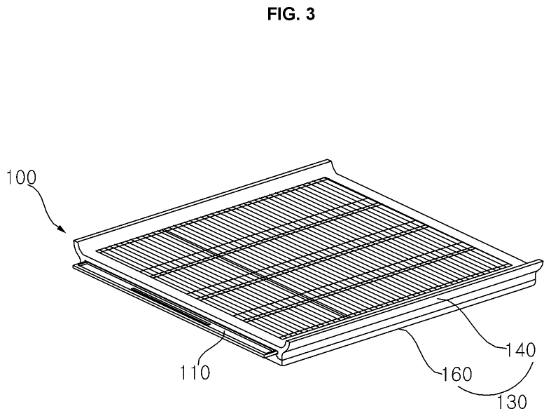

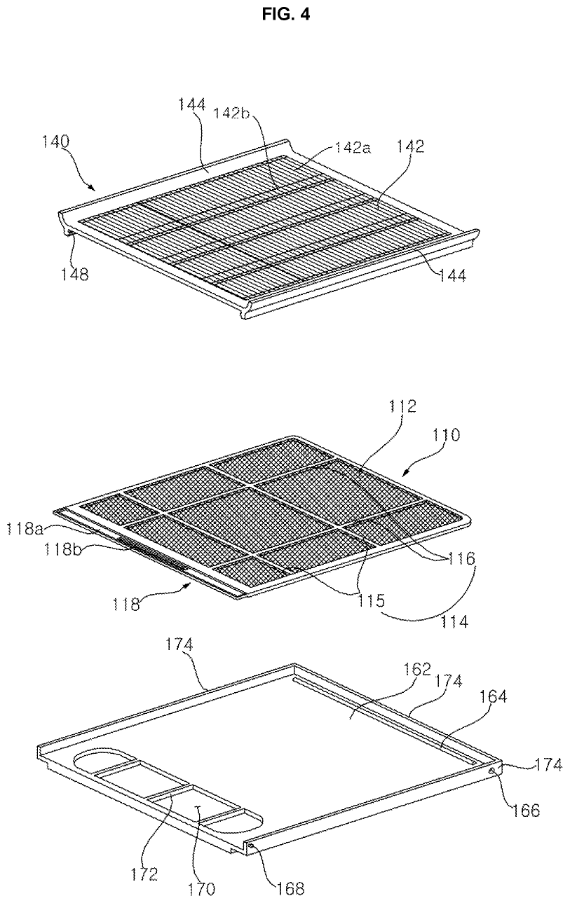

Referring to FIGS. 3 and 4, the filter module 100 includes: the module cover 130 disposed at the upper surface of the machine compartment 20 so that foreign substances of the treatment space 10s falls down; and the filter unit 110 disposed to be withdrawn inwards of the module cover 130 so as to filter out foreign substances that falls to the module cover 130.

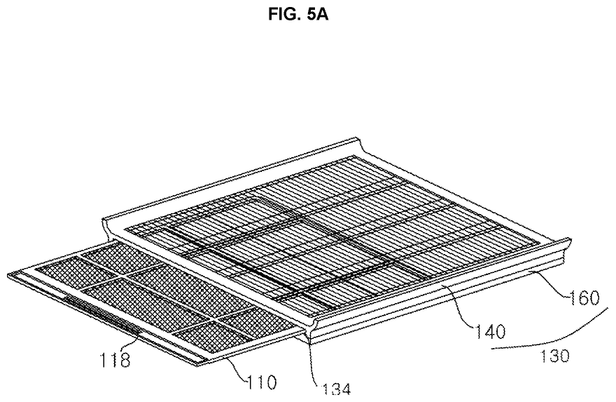

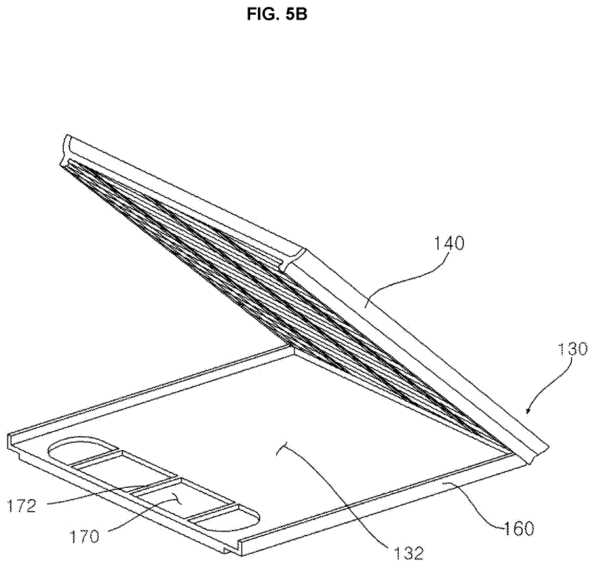

Referring to FIGS. 5 and 6, the module cover 130 includes: the lower plate 160 which is disposed at a lower side of the filter unit 110 and which accommodates foreign substances falling down from the filter unit 110, and an upper grille (or grille) 140 which is coupled to the lower plate 160 to form an accommodation space 132 where the filter unit 110 is accommodated and which covers an upper side of the filter unit 110.

Referring to FIG. 4, the lower plate 160 has a plate shape and includes a plate portion (or plate wall) 162 having one side in which a suction port corresponding hole 170 is formed, and an edge portion (or edge protrusion) 174 protruding upward from a circumferential surface of the plate portion 162.

Referring to FIG. 4, when the filter module 100 is mounted in the filter module mounting surface 22 of the machine compartment 20, the suction port corresponding hole 170 is disposed above the suction port 22a. At least one rib 172 for strength reinforcement is formed in the suction port corresponding hole 170.

When the filter module 100 is mounted in the filter module mounting surface 22, the lower plate 160 is disposed at a predetermined interval upwards from the filter module mounting surface 22. This is to secure a space in which a condensate created from air containing moisture and flowing in the treatment space 10s is drained to the suction port 22a. At the rear of the plate portion 162, a locking protrusion 164 for fixing a position when the filter unit 110 is inserted into the module cover 130 may be formed. The locking protrusion 164 may be disposed adjacent to the edge portion 174 formed at the rear end of the plate portion 162. When the filter unit 110 is inserted into the module cover 130, the locking protrusion 164 is inserted into a locking groove 115a of the filter unit 110, thereby limiting movement of the filter unit 110.

The edge portion 174 may be formed at both ends and a rear end of the plate portion 162. No edge portion is formed at a front end of the plate portion 162 since an opening through which the filter unit 110 is to be withdrawn is formed therein. Foreign substances falling down on the filter module 100 may be collected on the lower plate 160 by the edge portion 174.

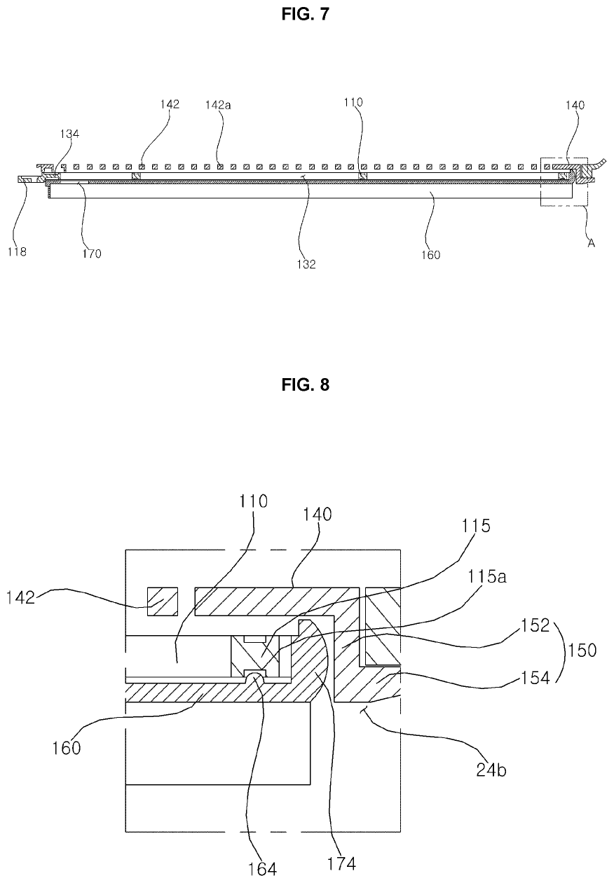

Referring to FIG. 8, the edge portion 174 disposed at the rear of the plate portion 162 may be formed in a semicircular shape convex outward in order to prevent interference with a fixing guide 150 of the upper grille 140.

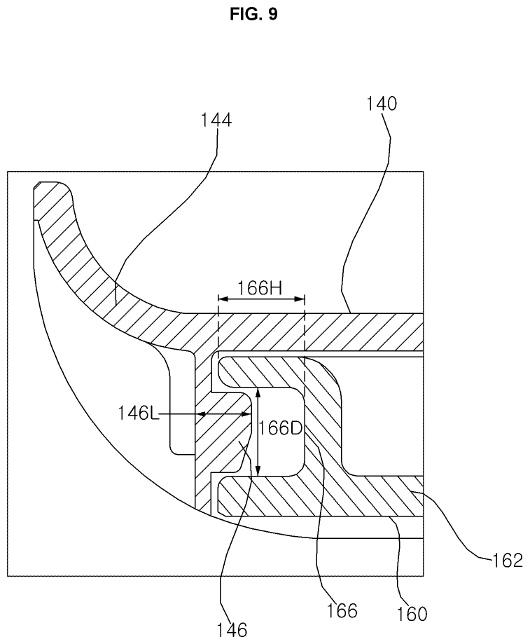

At the rear of each of both ends of the lower plate 160, a hinge portion 166 to be hinged with the upper grille 140 is disposed. Referring to FIG. 9, the hinge portion 166 of the lower plate 160 is hinged with a hinge corresponding portion 146 of the upper grille 140. The hinge portion 166 may be a hinge pin or a hinge hole to which the hinge pin is connected, and the hinge corresponding portion 146 may be a hinge hole or a hinge pin which corresponds to the hinge pin or the hinge hole of the hinge portion 166.

Referring to FIG. 9, the hinge portion 166 of the lower plate 160 according to an embodiment of the present disclosure has a hinge hole formed therein, and the hinge counter portion 146 of the upper grille 140 has a hinge pin formed therein. The hinge portion 166 may be formed behind the edge portion 174 disposed at the both side ends of the plate portion 162. However, it should be appreciated that in another example, the hinge portion 166 of the lower plate 160 according to an embodiment of the present disclosure has a hinge pin formed therein, and the hinge counter portion 146 of the upper grille 140 has a hinge hole formed therein.

A protruding length 146L of the hinge corresponding portion 146 having a hinge pin shape is formed smaller than a depth 166H of the hinge hole formed in the hinge portion 166 and a diameter 166D of the hinge hole. Accordingly, a user is able to easily remove the upper grille 140 from the lower plate 160 by manipulation.

Referring to FIG. 4, a coupling portion 168 to be coupled to the upper grille 140 is disposed at the front of each of the both ends of the lower plate 160. The coupling portion 168 of the lower plate 160 may be hooked with a coupling corresponding portion 148 of the upper grille 140. Therefore, by the user's manipulation, the coupling portion 168 of the lower plate 160 and the coupling corresponding portion 148 of the upper grille 140 may be coupled or decoupled. When the coupling portion 168 of the lower plate 160 and the coupling corresponding portion 148 of the upper grille 140 are decoupled, the upper grille 140 rotates along a hinge axis hinged to the rear side, thereby opening the inside of the module cover 130.

When the coupling portion 168 of the lower plate 160 and the coupling corresponding portion 148 of the upper grille 140 are coupled, the accommodation space 132 in which the filter unit 110 is disposed may be formed between the lower plate 160 and the upper grille 140.

The coupling portion 168 of the lower plate 160 has a hook shape, and the coupling corresponding portion 148 of the upper grille 140 may have a shape of a locking protrusion with which that the coupling portion 168 in the hook shape is locked.

Referring to FIG. 4, the upper grille 140 is coupled to the lower plate 160 from above the lower plate 160. The upper grille 140 includes a grille portion 142 disposed at the upper side of the filter unit 110, a curved surface periphery disposed at both ends of the grille portion 142 and forming a curved surface extending upward in a direction away from the grille portion 142, and a fixing guide 150 disposed at a rear end of the grille portion 142 and inserted into an insertion space 24b of the discharge port cover 24 to fix the filter module 100 to an upper side of the machine compartment 20.

As described above, the upper grille 140 further includes the hinge corresponding portion 146 and the coupling corresponding portion 148, which are in a structure for coupling with the lower plate 160.

The grille portion 142 may be formed with a plurality of horizontal grills (or left-right grills) 142a formed in the left and right directions and a plurality of vertical grills (or front-rear grills) 142b formed in the front-rear direction. The plurality of horizontal grills 142a may be arranged at short intervals, compared to the plurality of vertical grills 142b.

The curved end portion (or side wall) 144 are disposed at each of the both ends of the grille portion 142. The curved end portion 144 is convex toward the lower side and forms a curved surface toward the upper side in a direction away from the grille portion 142. Accordingly, foreign substances falling from the treatment space may be induced to move to the grille portion 142 along the curved end portion 144.

Referring to FIG. 8, the fixing guide 150 protrudes rearward from a rear end of the grille portion 142 and is inserted into the insertion space 24b formed at a lower side of the discharge port cover 24. When the fixing guide 150 is inserted into the insertion space 24b formed at the lower side of the discharge port cover 24, the module cover 130 or the filter module 100 is stably mounted at the upper side of the machine compartment 20.

The fixing guide 150 is bent at the rear end of the grille portion 142 to extend downward, and the fixing guide 150 includes a rear cover 152 covering the rear of the lower plate 160, and a rear protrusion (or lip)_154 bent at a lower end of the rear cover 152 to extend rearward. The rear protrusion 154 may have a shape and a size each corresponding to the insertion space 24b, so that the rear protrusion 154 can be inserted into the insertion space 24b formed at the lower side of the discharge port cover 24.

Referring to FIG. 10, a lower protruding portion 171 extending in a downward direction and inserted into the suction port 22a is formed in a front of the lower plate 160. The lower protruding portion 171 is formed as a circumference of the suction port corresponding hole 170. The lower protruding portion 171 may be held in the front holding portion 25.

Referring to FIG. 10, when the lower plate 160 and the upper grille 140 are coupled, the accommodation space 132 in which the filter unit 110 is disposed is formed inside, and the opening 134 through which the filter unit 110 can be withdrawn is formed outside. When the module cover 130 is mounted at the upper side of the machine compartment 20, the opening 134 is located above the front holding portion 25. Accordingly, the filter unit 110 inserted through the opening 134 may be inserted and withdrawn in the forward direction even when the module cover 130 is mounted at the upper side of the machine compartment 20.

Referring to FIG. 4, the filter unit 110 includes: a filter for filtering out foreign substances; a filter frame 114 fixing the filter 112 and capable of being inserted or withdrawn into and from the accommodation space 132 of the module cover 130; and a handle 118 exposed to an outside of the opening 134 of the module cover 130 when the filter unit 110 is inserted into the module cover 130.

Referring to FIG. 4, the filter frame 114 may include a plurality of horizontal frames (or left-right frame section) 115 formed in the left-right direction and a plurality of vertical frames (or front-rear frame section) 116 formed in the front-rear direction. A sectional view of the filter frame 114 may have a shape in which the length increases in the vertical direction in a direction from the center to both ends for strength reinforcement. Accordingly, the locking groove 115a concave to the center may be formed at a lower side and an upper side.

Referring to FIG. 8, the locking protrusion 164 of the lower plate 160 may be inserted into the locking groove 115a formed in a horizontal frame 115 disposed at a rear end. Therefore, when the filter unit 110 is inserted into the accommodation space 132 of the module cover 130, the locking protrusion 164 is caught by the locking groove 115a formed in the horizontal frame 115 disposed at the rear end, thereby fixing the placement of the filter unit 110.

Referring to FIG. 10, the handle 118 has a shape extending forward of the filter frame 114. The handle 118 is exposed to the front of the opening 134 when the filter unit 110 is mounted in the module cover 130. When the filter unit 110 is mounted in the module cover 130, the handle 118 is disposed above the front holding portion 25. When the filter unit 110 is mounted in the module cover 130, the handle 118 is disposed below the slope 40.

The handle 118 includes a handle groove 118a formed in a downward direction from an upper side. A handle hole 118b opened in a vertical direction is included at one side of the handle groove 118. When the door 30 closes the treatment space 10s, an end protruding toward the treatment space of the slope 40 is located above the handle groove 118a.

According to the clothing treatment device of the present disclosure, there are one or more of the following aspects. First, the filter module is disposed above the upper side of the machine compartment to filter out flowing foreign substances or accommodate falling foreign substances, and thus, there is an advantage that the inside of the treatment space can be maintained clean. Accordingly, it is possible to maintain clothing refreshed in the treatment space. Second, since the filter module is detachably held at an upper side of the machine compartment, a user can detach the filter module and clean the filter module separately, and thus, foreign substances received therein can be easily treated. Third, the filter module is composed of a module cover and a filter unit and the filter unit is slidingly coupled from the module cover and is disposed capable of being inserted or withdrawn even in a state in which the filter module is mounted at the upper side of the machine compartment, and thus, there is an advantage that a user can easily separate and use the filter unit only. The aspects of the present disclosure are not limited to the aspects mentioned above, and other aspects which are not mentioned will be clearly understood by those skilled in the art from the description of the claims.

The present disclosure provides a clothing treatment device capable of removing foreign substances accumulated at a lower side of a treatment space. The present disclosure also provides a clothing treatment device capable of easily collecting foreign substances falling down on the lower side of the treatment space so that the foreign substances can be conveniently removed. The present disclosure also provides a clothing treatment device capable of maintaining the inside of the treatment space of the clothing treatment device in a refreshed state. The aspects of the present disclosure are not limited to the aforementioned aspects, and other aspects which are not mentioned will be clearly understood by those skilled in the art from the following description.

In an aspect, the clothing treatment device is provided. The clothing device includes: a cabinet forming a treatment space in which clothing is accommodated, the cabinet opened at a front; a door configured to open and close the opened front of the cabinet; a machine compartment disposed below the treatment space in the cabinet and having a suction port and a discharge port, the suction port through which air of the treatment space is suctioned, the discharge port through which air is discharged to the treatment space; and a filter module disposed below the treatment space and configured to filter out foreign substances from air being introduced through the suction port or collect foreign substances falling down from the treatment space to the machine compartment. Accordingly, it is possible to process foreign substances accumulated on the upper side of the machine compartment.

Specifically, the filter module may include: a module cover disposed at a lower side of the treatment space; and a filter unit disposed inside the module cover so that the filter unit is allowed to be withdrawn toward a front of the module cover when the door opens the opened front of the cabinet, the filter unit which filters out foreign substances falling down on the module cover. The filter module may be disposed to be detachable upwards of the machine compartment. Accordingly, a user is able to remove foreign substances accumulated on the filter module or foreign substances filtered out.

An accommodation space where the filter unit is accommodated and an opening through which the filter unit is to be inserted and withdrawn may be formed in the module cover, and the filter unit may be slidably coupled to the module cover. The module cover may include: a lower plate disposed at a lower side of the filter unit and receiving foreign substances falling down from the filter unit; and an upper grille coupled to the lower plate to form an accommodation space where the filter unit is accommodated.

The lower plate and the upper grille may be hinged to each other at one side and hooked to each other at the other side. Accordingly, it is possible to clean the inside of the module cover by easily opening/closing or separating the inside of the filter cover. When the lower plate and the upper grille are coupled, an opening through which the filter unit is to be inserted from or withdrawn toward the front may be formed. Accordingly, it is possible to easily separate, clean, and replace the filter unit only.

The lower plate may include: a plate portion having a plate shape and forming a space for collecting foreign substances falling down from the treatment space to an upper side of the machine compartment; and an edge portion protruding upwards from a circumferential surface of the plate portion. The plate portion may have a suction port corresponding hole formed therein, the suction corresponding hole which is opened above the suction port in a vertical direction. Accordingly, a space where foreign substances are accommodated may be formed, and air may be allowed to flow through the suction port.

A fixing protrusion for fixing a position of the filter unit inserted into the module cover may be formed in an inner end of the lower plate. Accordingly, it is possible to fix the filter unit inserted into the module cover.

The filter unit may include: a filter configured to filter out foreign substances; and a plurality of filter frames to be inserted into or withdrawn from the accommodation space of the module cover, the plurality of filter frames which is arranged in a grid shape and fixes the filter. A locking groove concave inwards may be formed in one of the plurality of filter frames, so that the fixing protrusion is locked.

The upper grille may include a grille portion disposed at an upper side of the filter unit and a curved end portion disposed at each of both ends of the grille portion to extend in left and right directions, the curved end portion which forms a curved surface extending upwards in a direction away from the grille portion. Accordingly, it is possible to cause foreign substances falling down from the treatment space to the filter unit through the grille portion.

A discharge port cover forming a discharge port and disposed obliquely upwards may be disposed at a rear of the filter module, and the upper grille may include a fixing guide disposed at a rear end of the grille portion and inserted into an insertion space formed between the discharge port cover and the machine compartment. Accordingly, the filter module may be fixed to the upper side of the machine compartment.

A mounting surface in which the filter module is mounted may be formed at an upper side of the machine compartment, and the lower plate may be spaced a predetermined distance from the mounting surface of the machine compartment. The door may include a slope formed in an inner surface toward the treatment space and protruding toward the treatment space, and the slope may be located above the filter module when the door closes the treatment space. Accordingly, the filter module may not be intervened even by opening/closing of the door.

The filter unit may include a handle exposed to a front of the opening when the filter unit is inserted into the module cover. Accordingly, a user is able to easily withdraw or insert the filter unit.

The machine compartment may include a front holding portion which is formed at a front of the suction port on an upper surface and in which the lower plate is held. Accordingly, the filter module may be held above the machine room. When the filter module is mounted at the upper side of the machine compartment, the handle may be located above the front holding portion. Accordingly, even though the filter module is mounted at the upper side of the machine compartment, the filter unit may be easily withdrawn toward the front.

In one example, a laundry treatment device may comprise: a cabinet forming a treatment space into which laundry is received, the cabinet having an opened front; a door configured to open or close the opened front of the cabinet; a machine compartment provided below the treatment space in the cabinet, a suction port and a discharge port being provided between the machine compartment and the cabinet, air of the treatment space being suctioned through the suction port, and air being discharged into the treatment space air through the discharge port; and a filter module, wherein the filter module includes: a module cover configured to be positioned in the treatment space and over the suction port; and a filter configured to be received inside the module cover, to be withdrawn toward a front of the module cover, and to filter foreign substances in air being suctioned through the suction hole or falling down onto the module cover from the treatment space.

The filter module may be configured to be detachable by moving upwards of the machine compartment. An accommodation space where the filter is received and an opening through which the filter is inserted into or withdrawn from accommodation space may be formed in the module cover, and the filter may be slidably coupled to the module cover.

The module cover may include: a lower plate provided below the filter and configured to receive foreign substances falling down from the filter; and an upper grille coupled to the lower plate to form an accommodation space where the filter is received. The lower plate and the upper grille may be hingedly connected to each other at one side and are hooked to each other at the other side.

The module cover may include an opening through which the filter is inserted from a front of the cabinet or withdrawn toward the front of the cabinet. The lower plate may include: a plate region having a planar shape and forming a space for collecting foreign substances falling down from the treatment space and toward the machine compartment; and at least one edge protrusion extending upwards from an end of the plate region, wherein the plate region has a hole formed therein, the hole being positioned above the suction port in a vertical direction.

A fixing protrusion for fixing a position of the filter when inserted into the module cover may be formed in a rear end of the lower plate. The filter may include: a plurality of filter frame walls configured to be inserted into or withdrawn from the accommodation space of the module cover, the plurality of filter frame walls being arranged in a grid shape to fix the filter, wherein a locking groove that is concave inwards may be formed in one of the plurality of filter frame walls and is configured to receive at least a portion of the fixing protrusion.

The upper grille may include a grille region having a plurality of openings and provided above the filter and curved ends provided at edges of the grille regions to extend in left and right directions, each of the curved ends forming a curved surface extending upwards in a direction away from the grille region. A discharge port cover, forming an opening though which air from the discharge port passes into the treatment space and extending obliquely upwards may be provided at a rear of the filter module, and the upper grille may include a fixing guide provided at a rear end of the grille portion and configured to be inserted into an insertion space formed between the discharge port cover and the machine compartment.

A mounting surface in which the filter module is mounted may be formed above the machine compartment, and the lower plate may be spaced a prescribed distance from the mounting surface. The door may include: a sloped region formed in an inner surface of the door and protruding toward the treatment space, and a distal edge of the slope region may be located above the filter module when the door closes the treatment space.

The filter may include a handle that exposed to a front of the opening when the filter is inserted into the module cover. The laundry treatment device may further comprise a front liner which is formed at a front of the suction port. When the filter module is mounted above the machine compartment, the handle is located above a portion of the front liner.

In another example, a laundry treatment device comprises: a cabinet forming a treatment space in which laundry is received, the cabinet including a suction port through which air is suctioned out of the treatment space; a housing configured to be positioned to cover the suction port; and a filter configured to be received inside the housing and to filter foreign substances in air being suctioned through the suction hole or falling down onto the filter from the treatment space, wherein the housing includes: a tray provided below the filter and having an opening corresponding to the suction port; and a grill that is coupled to the tray to form an accommodation space in which the filter is received, wherein the grille is hingedly connected to the tray to selectively open upwards.

The grille may include: a grille region above the filter, and at least one end regions that extend from at least one end of the grill region, the end region extending upwards in a direction away from the grille region. The housing may include an opening through which the filter is inserted into the accommodation space. The filter may include a handle that exposed when the filter is inserted into the housing through the opening.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A laundry treatment device, comprising:
a cabinet forming a treatment space in which laundry is received, the cabinet having an opened front;
a door configured to open or close the opened front of the cabinet;
a machine compartment provided below the treatment space in the cabinet, a suction port and a discharge port being provided in the treatment space, air of the treatment space being suctioned through the suction port, and air being discharged into the treatment space air through the discharge port; and
a filter module that includes:
a module cover configured to be positioned at a lower region of the treatment space and over the suction port; and
a filter configured to be received inside the module cover and to be withdrawn toward a front of the module cover when the door opens the opened front of the cabinet, the filter being positioned to capture foreign substances in air being suctioned through the suction hole or falling down on the module cover from the treatment space.

2. The laundry treatment device of claim 1, wherein the filter module is configured to be detachable upwards of the machine compartment.

3. The laundry treatment device of claim 1,
wherein an accommodation space where the filter is received and an opening through which the filter is inserted into or withdrawn from accommodation space are formed in the module cover,
wherein the filter is slidably coupled to the module cover.

4. The laundry treatment device of claim 1, wherein the module cover includes:
a lower plate provided below the filter and configured to receive foreign substances falling down from the filter; and
an upper grille coupled to the lower plate to form an accommodation space where the filter is received.

5. The laundry treatment device of claim 4, wherein the lower plate and the upper grille are hingedly connected to each other at one side and are hooked to each other at the other side.

6. The laundry treatment device of claim 4, wherein when the lower plate and the upper grille are coupled, the module cover includes an opening through which the filter is inserted from a front of the cabinet or withdrawn toward the front of the cabinet.

7. The laundry treatment device of claim 4, wherein the lower plate includes:
a plate region having a planar shape and forming a space for collecting foreign substances falling down from the treatment space and toward the machine compartment; and
at least one edge protrusion extending upwards from an end of the plate region, wherein the plate region has a hole formed therein, the hole being positioned above the suction port in a vertical direction.

8. The laundry treatment device of claim 4, wherein a fixing protrusion for fixing a position of the filter when inserted into the module cover is formed in a rear end of the lower plate.

9. The laundry treatment device of claim 8, wherein the filter includes:
a plurality of filter frame walls configured to be inserted into or withdrawn from the accommodation space of the module cover, the plurality of filter frame walls being arranged in a grid shape to fix the filter,
wherein a locking groove that is concave inwards is formed in one of the plurality of filter frame walls and is configured to receive at least a portion of the fixing protrusion.

10. The laundry treatment device of claim 4, wherein the upper grille includes a grille region having a plurality of openings and provided above the filter and curved ends provided at edges of the grille regions to extend in left and right directions, each of the curved ends forming a curved surface extending upwards in a direction away from the grille region.

11. The laundry treatment device of claim 10,
wherein a discharge port cover, forming an opening though which air from the discharge port passes into the treatment space and extending obliquely upwards is provided at a rear of the filter module, and
wherein the upper grille includes a fixing guide provided at a rear end of the grille portion and configured to be inserted into an insertion space formed between the discharge port cover and the machine compartment.

12. The laundry treatment device of claim 6,
wherein a mounting surface in which the filter module is mounted is formed above the machine compartment,
wherein the lower plate is spaced a prescribed distance from the mounting surface.

13. The laundry treatment device of claim 12, wherein the door incudes:
a sloped region formed in an inner surface of the door and protruding toward the treatment space, and
wherein a distal edge of the slope region is located above the filter module when the door closes the treatment space.

14. The laundry treatment device of claim 6, wherein the filter includes a handle that exposed to a front of the opening when the filter is inserted into the module cover.

15. The laundry treatment device of claim 12, further comprising a front liner which is formed at a front of the suction port.

16. The laundry treatment device of claim 15, wherein when the filter module is mounted above the machine compartment, the handle is located above a portion of the front liner.

17. A laundry treatment device, comprising:
a cabinet forming a treatment space in which laundry is received, the cabinet including a suction port through which air is suctioned out of the treatment space;
a housing configured to be positioned to cover the suction port; and
a filter configured to be received inside the housing and to filter foreign substances in air being suctioned through the suction hole or falling down onto the filter from the treatment space,
wherein the housing includes:
a tray provided below the filter and having an opening corresponding to the suction port; and
a grill that is coupled to the tray to form an accommodation space in which the filter is received, wherein the grille is hingedly connected to the tray to selectively open upwards.

18. The laundry treatment device of claim 17, wherein grille includes:
a grille region above the filter, and at least one end regions that extend from at least one end of the grill region, the end region extending upwards in a direction away from the grille region.

19. The laundry treatment device of claim 17, wherein the housing includes an opening through which the filter is inserted into the accommodation space.

20. The laundry treatment device of claim 19, wherein the filter includes a handle that exposed when the filter is inserted into the housing through the opening.
